(19) United States
(12) Patent Application Publication
(10) Pub. No.: US 2011/0001892 A1
(43) Pub. Date: Jan. 6, 2011

(54) Toy with Video Display Screen

(76) Inventor: Sharron C. Gay, Coral Springs, FL (US)

Correspondence Address: Law Office of Andrew Berks, 45 Wall St, Suite 2203, New York, NY, 10005, US

(21) Appl. No.: 12/820,185

(22) Filed: Jun. 22, 2010

Related U.S. Application Data
(63) Continuation-in-part of application No. 12/497,928, filed on Jul. 6, 2009.

(51) Int. Cl. H04N 5/64

(52) U.S. Cl. 348/836; 348/E05.128

(57) ABSTRACT

This invention provides a toy, such as a plush stuffed animal, having a video display screen for viewing video content, and optionally including audio playback capabilities. The toy includes a microprocessor, memory, a power supply, and control means for selecting content to be displayed or heard.

This application claims the benefit of U.S. application Ser. No. 12/497,928, filed Jul. 6, 2009, the contents of which are incorporated by reference.

### FIELD OF THE INVENTION

The present invention relates generally to toys or amusement devices with a digital picture display screen embedded within a plush toy.

### BACKGROUND OF THE INVENTION

“Video picture frame” devices are well known in the art. These devices are designed to display photographs and comprise a video screen meant to emulate an ordinary picture frame, a small computer, and means for transferring computer picture files (such as “.jpg”-type files) to the device for display. Video picture frame devices are typically used as amusement devices to display a continuous slide show of personal photographs. Examples of such devices are disclosed in U.S. Pat. No. 6,396,472, U.S. Pat. No. 6,975,308, U.S. Pat. No. 7,411,578, U.S. Patent Publication No. 2008/0303805, and PCT Publication No. WO 2008/064895.

In the field of toys and amusement devices, there is an ongoing consumer demand for new and innovative display apparatus. This invention relates generally to embedding a digital picture display screen into the body of a plush toy, doll, or similar amusement device. Such a toy is intended to sit on a desk or shelf and continuously display photographs for viewing pleasure.

Various toys such as dolls, toy animals, and plush toys are known in the art with electrical or electronic devices embedded therein, that are intended to enhance the amusement of the toy. For example, U.S. Pat. No. 4,237,647 discloses a doll with a battery powered music box. Another example is U.S. Pat. No. 4,802,879 which discloses an action figure with a microprocessor and a liquid crystal (LCD) display and to simulate “life functions” of the toy. Another example is U.S. Pat. No. 6,000,987, which discloses a toy doll or animal with an interior compartment or backpack containing an audio device to record and play sounds. A related toy is that disclosed in U.S. Pat. No. 5,059,149 which provides a stuffed animal toy with a compartment for a book and optionally an audio tape player.

None of the aforementioned toys take advantage of the currently-available technology to provide a toy with a full range of integrated video features.

### SUMMARY OF THE INVENTION

The present invention provides for a toy such as a plush stuffed animal or a doll with a video display screen integral therewith for the display of video content, such as photographs or moving action video clips. In an embodiment, an audio device such as a speaker or electronic connectors for external speakers may be integrated into the toy, for playing music, voice compositions, or other sounds with the video content.

The toy of this invention also requires a microcomputer with memory for the storage of data, a power supply, and data communication for the transfer of data files to the toy. Additionally, sufficient controls are provided for the user to direct the content to be displayed.

### BRIEF DESCRIPTION OF THE DRAWINGS

FIG. 1 shows a representative embodiment of a toy with a video screen and controls according to this invention.

FIG. 2 is block diagram of representative electronic components of the present invention.

FIG. 3 is a representative flow chart of the operation of video and audio features of the present invention.

FIG. 4 is a view of the video display screen and optional remote control.

FIG. 5 shows two variations of another embodiment of this invention. FIG. 5A shows a humanoid toy figure with the display screen of this invention. FIG. 5B is a variation of the same toy figure of FIG. 5A, but with certain components relocated to the rear of the toy.

### DETAILED DESCRIPTION OF THE INVENTION

This invention provides a toy having a video display screen, including a toy with a body and a video display screen incorporated therein; a microprocessor comprising data communication means and memory means for storage of data files, wherein the data files comprise video content and optionally audio content; a power supply; and control means for selecting a data file, wherein the video screen displays video content stored in the selected data file. The toy may further include audio playback capabilities selected from a speaker incorporated into the body of the toy, an audio output connector for use with external speakers, and a Bluetooth transceiver, or any combination of these.

In another embodiment, this invention provides a method of viewing digital video content, including a toy with a body and a video display screen incorporated therein; a microprocessor comprising data communication means and memory means for storage of data files, wherein the data files comprise video content and optionally audio content; a power supply; and control means for selecting a data file, wherein the video screen displays video content encoded in the data file for viewing.

In another embodiment, this invention provides a method of viewing digital video content and listening to audio content, including a toy with a body and a video display screen incorporated therein; a microprocessor comprising data communication means and memory means for storage of data files, wherein the data files comprise video content and optionally audio content; a power supply; control means for selecting a data file; and audio playback capabilities selected from a speaker incorporated into the body of the toy, an audio output connector for use with external speakers, a Bluetooth transceiver, or any combination thereof, wherein the video screen displays video content and the audio playback capabilities provide audio content for viewing and listening.

The toys of this invention are objects of amusement, primarily designed to have a pleasing appearance, that a person would want to keep in a location that can be easily viewed, in for example, a home or workplace. This invention provides for toys that may be stuffed animals, humanoid dolls, or other similar toys that contain a screen for the display of video content and associated electronic components, and optionally a speaker for audio playback. In a preferred embodiment, the toy is a plush toy, meaning a stuffed animal toy made from a fabric having a cut nap or pile. The stuffed toy may also be a fanciful object, not necessarily representing an animal. For example, the toy may represent a fantasy animal (such as a dragon) or an article of furniture.

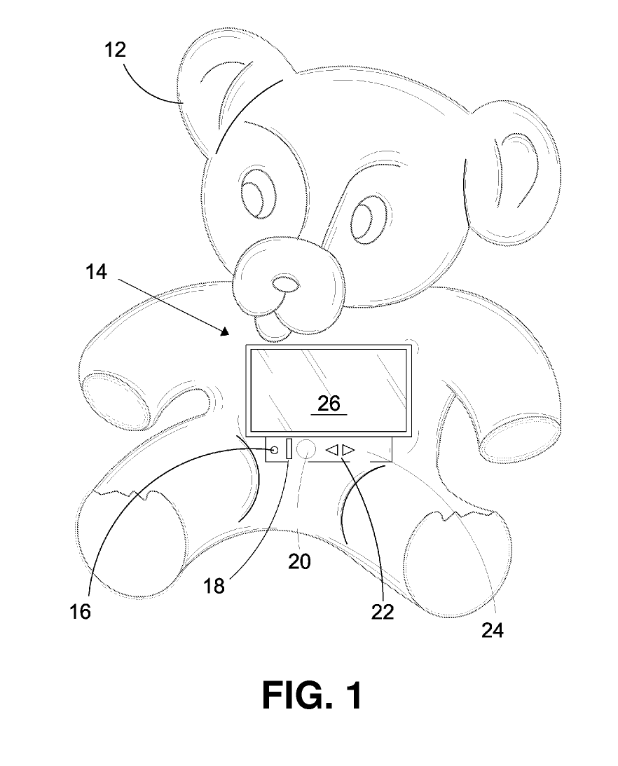

The toy animal or doll contains a video screen enabling a person to view video content on the screen. The purpose of the video screen embedded in the body of a stuffed animal toy is for amusement and enjoyment of photographic or video content. A representative illustration of this invention is shown in FIG. 1. The video screen of this invention will be facing forward as the toy is intended to be oriented. In a toy with a face, such as a humanoid or animal toy, the screen will generally be facing in the same direction as the face of the toy. The instant invention includes a toy body 12 and a video screen 26. Also shown in FIG. 1 are representative features such as an on/off switch 16, SD card port 24, USB port 18, speaker 20 and user select controls 22.

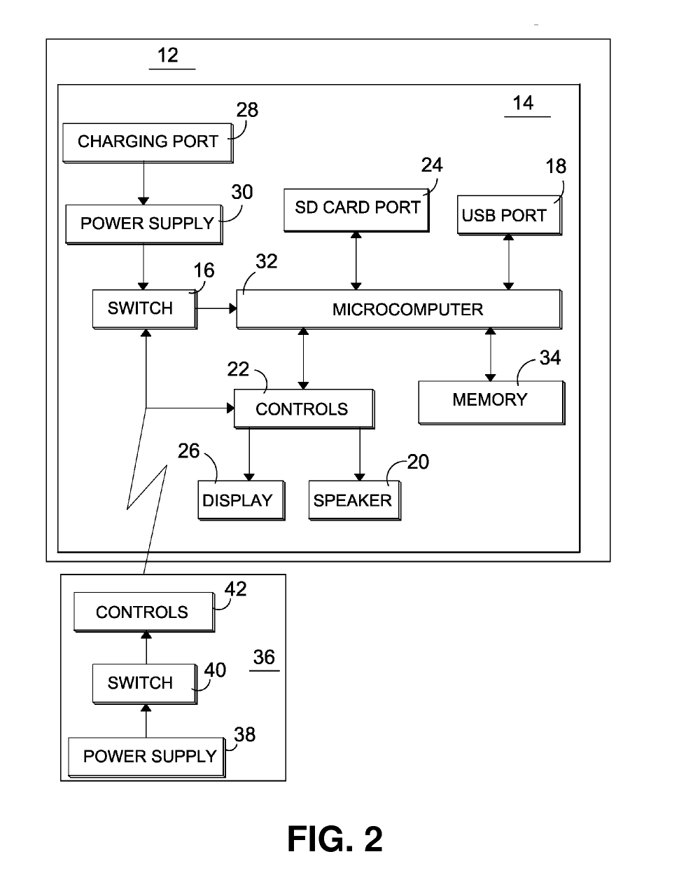

Several electronic components are necessary to operate the video and audio aspects of this invention. Typical components that may be present are shown in the electronic block diagram 14 in FIG. 2. A microcomputer 32 is provided, which would have a microprocessor integral therewith. A power supply 30 is necessary, and may be a battery or a may comprise a power cord for connection to a wall outlet. If the power supply is a battery, it may be rechargeable or a disposable battery. If the battery is rechargeable, a charging port 28 is provided. In typical embodiments with a rechargeable battery, an external battery charger will be employed, that may have a wall cord and voltage regulator. Typical rechargeable battery packs are those based on nickel-cadmium, nickel-metal hydride (NiMH), or lithium ion batteries. The voltage regulator in an embodiment with a rechargeable battery is connected to the toy with a special power supply cord and jack.

Microcomputers 32 suitable for this invention are well known in the art, and are used in cellular telephone-type devices, mp3 players, digital cameras and the like. Such microcomputers contain a microprocessor, controller circuitry, operating system and programming functions on non-volatile ROM, and data storage in RAM or flash memory (34). In yet another embodiment, a hard disk may be employed as a data storage device.

The microcomputer of the instant invention requires means for data communication with other devices. Such means may include, for example, a flash memory card reader 24; a USB connector 18; a firewire IEEE 1394 connector; an Ethernet connector; or a wireless data connection, such as IEEE 802.11xx. Typical flash memory card formats include SD Cards, but other ejectable flash memory devices are available. Similarly, USB flash memory devices may be used in the USB connector. The communication means are used to transfer data files to the microcomputer incorporated into the inventive toys, and may also be used to transfer data files from the inventive toys to other computers.

Typically, the data files that will be employed in the inventive device will be contain photographic, video, and audio data content. The file types may include jpeg, mp3, mpeg, mp4, way, tiff, or wma files. This is not intended to be a complete list, and there are many other file formats that provide content suitable for the toys of this invention. All of the aforementioned file types encode video content, and several also encode accompanying audio content.

The video screen 26 of this invention will typically be an LCD or LED based screen. The size will be dependent on the toy. Such screens are well known in the art of hand-held computing devices, mobile telephones, and other computer display screens.

In an embodiment, this invention also has the capability to play music or other audio content. In an embodiment, one or more speakers 20 may be incorporated into the toy of this invention. In another embodiment, an industry standard jack for connection to headphones or external speakers may be provided. In another embodiment, the inventive toy may contain an industry standard Bluetooth transceiver for communication to a Bluetooth device. Thus, a slide show or video clip may be accompanied by a sound track such as music or sound from the video that can be heard by a person near the toy.

The instant invention also has a control means for selecting video content. By “video content” is meant the video files (single frame pictures, slide shows of a plurality of single frame pictures, or moving action video clips) that will be displayed on the video screen. The control means may also be used to select audio content, and to change the volume of the audio output. Also provided in an embodiment is an on/off switch.

The control means of the instant invention may employ switches or pushbuttons mounted on the body of the toy, a remote control, or touch screen controls, or any combination thereof.

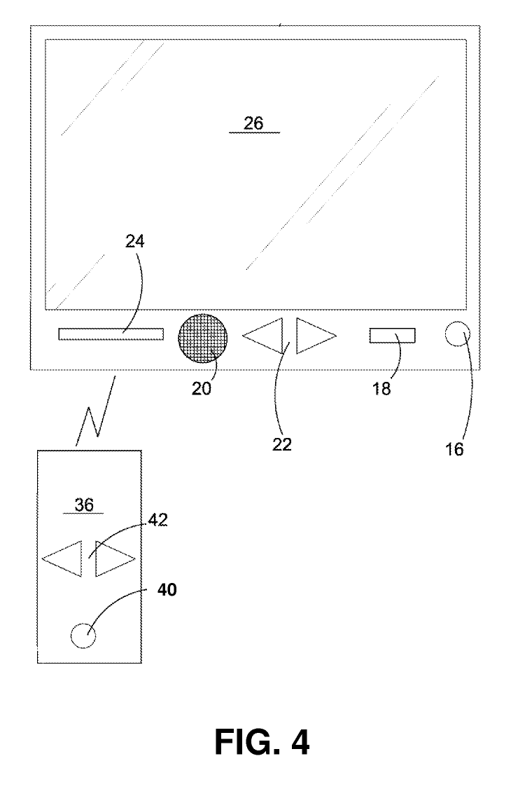

In an embodiment, a remote control 36, shown in FIGS. 2 and 4, may be provided to control the video or audio content of the toy. By the term “video” here, it is meant that both still, single frame photographs, and that motion picture, i.e., moving action, content is encompassed in the definition. The remote control includes a power supply 38, which is typically a disposable battery, one or more switches 40 and controls 42, and wireless means for communicating with the toy. Such devices are well known in the art, and typically function to switch the display device on or off, to select content, and control the audio volume.

In another embodiment, the toy may include a touch screen with controls integrated therewith. In this embodiment, the video screen is sensitive to touching, and regions of the video screen are marked as “buttons” that can be touched to control the video or audio usage of the toy.

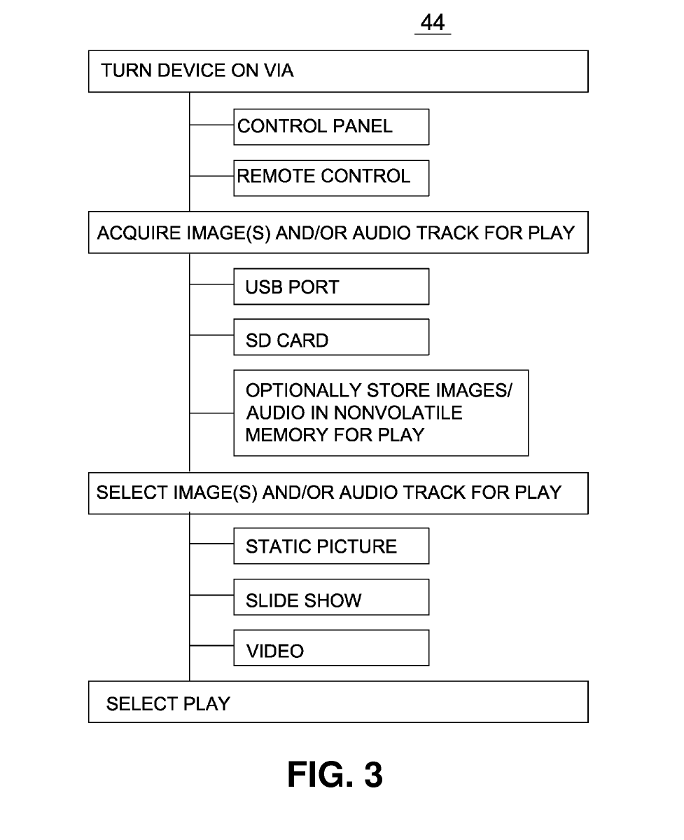

FIG. 3 provides a chart 44 of the functions that the inventive toy may provide. Shown is the method of operation of the present invention involving the steps of turning on the device, acquiring images and audio, selecting images and video for play and selecting play. Note that the inventive device may display one or more of a static picture, a slide show, or a video. By the term video in this context is meant to include moving action video, such as film clips. In addition to the video playback features of this toy, the user, in some embodiments may also select an audio file for playing simultaneously with the video content. By the term “slide show” is meant a series of still photographs that continuously cycle, with each picture displayed for a limited period of time before the next photograph is displayed. The time period may be, for example, 5 seconds to one minute, but other time periods may be used outside of this range.

FIG. 4 shows an embodiment of the video screen 26 and optional remote control 36. Also shown is an SD card port 24, USB port 18, user select controls 22, on/off switch 16 and speaker 20. The frame surrounding these embodiments would be visible from the front of the toy of this invention. At a minimum, the video screen 26 is visible from the front of the inventive toys. Also provided by the present invention is an optional remote control 36 having on/off switch 38 and controls 42 for selecting video and optionally audio content, and audio volume if audio is provided.

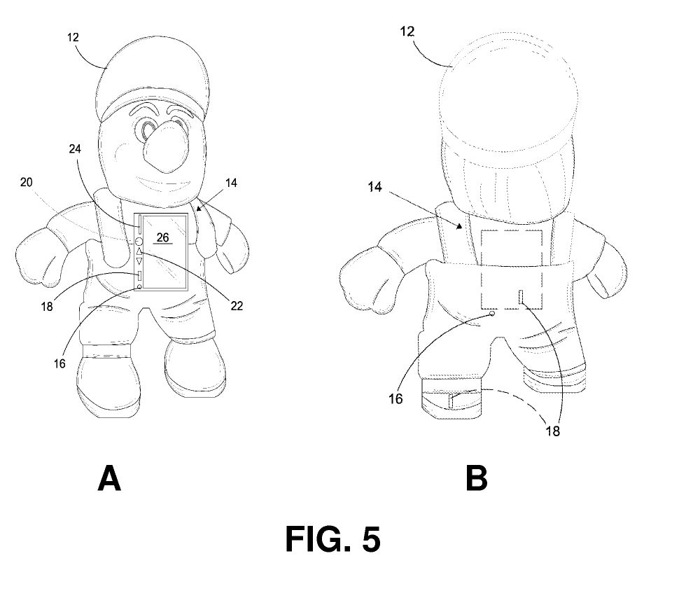

FIGS. 5A and 5B show illustrative views of toys of this invention having a video display screen. FIG. 5A shows a humanoid toy 12 having a video display screen 26, with an on/off switch 16, SD card port 24, USB port 18, speaker 20 and user select controls 22. FIG. 5B is a variation of the toy of FIG. 5A, but with certain controls or ports located on the back of the toy. The location of communication ports, switches, and controls is a design decision.

1. A toy having a video screen comprising
a. a toy with a body and a digital video screen incorporated therein;
b. a microprocessor comprising data communication means and memory means for storage of data files, wherein the data files comprise video content and optionally audio content;
c. a power supply; and
d. control means for selecting a data file;
wherein the video screen displays video content stored in the selected data file.

2. The toy of claim 1, further comprising audio playback capabilities selected from a speaker incorporated into the body of the toy; an audio output connector for use with external speakers; and a Bluetooth transceiver, or a combination thereof.

3. The toy of claim 1, wherein the toy is a plush toy.

4. The toy of claim 1, wherein the toy is a representation of an animal, a humanoid character, a fantasy character, or a fanciful object.

5. The toy of claim 1, wherein the video screen is oriented in the same direction as the toy is intended to be oriented.

6. The toy of claim 1, wherein the video content comprises single frame photographic images, or moving action video which are stored in the data files.

7. The toy of claim 1, wherein the data communication means is selected from a flash memory card reader; a USB connector; a firewire IEEE 1394 connector; an Ethernet connector; and a wireless data connection.

8. The toy of claim 1, wherein the memory means for the storage of video files is selected from random access memory; flash memory; and a disk drive, or a combination thereof.

9. The toy of claim 1, wherein the control means is used to select video files to be displayed.

10. The toy of claim 1, wherein the power supply is selected from a rechargeable battery, a disposable battery, or a power cord for connection to a standard electrical outlet.

11. The toy of claim 1, wherein the control means is selected from the group consisting of buttons or switches on the body of the toy; from touch screen controls; and from a remote control.

12. The toy of claim 2, wherein the control means is used to select audio files to be displayed.

13. A method of viewing digital video content, comprising
a. a toy with a body and a video display screen incorporated therein;
b. a microprocessor comprising data communication means and memory for storage of data files, wherein the data files comprise video content and optionally audio content;
c. a power supply; and
d. control means for selecting a data file;
wherein the video screen displays video content stored in the selected data file for viewing.

14. A method of viewing digital video content and listening to audio content comprising
a. a toy with a body and a video display screen incorporated therein;
b. a microprocessor comprising data communication means and memory means for storage of data files, wherein the data files comprise video content and audio content;
c. a power supply;
d. control means for selecting a data file; and
e. audio playback capabilities selected from a speaker incorporated into the body of the toy, an audio output connector for use with external speakers, a Bluetooth transceiver, or any combination thereof,
wherein the video display screen displays viewable video content and the audio playback capabilities provide listenable audio content, wherein the video and audio content are stored in the selected data file.
